(19) United States
(12) Patent Application Publication
(10) Pub. No.: US 2025/0118322 A1
(43) Pub. Date: Apr. 10, 2025

(54) CENTRAL DEVICE COMMUNICATING A PLURALITY OF PERIPHERAL DEVICES, AND OPERATION METHOD OF DATA FILTERING MODULE INCLUDED THEREIN

(71) Applicant: SAMSUNG ELECTRONICS CO., LTD., Suwon-si (KR)

(72) Inventors: Wondeuk YOON, Suwon-si (KR); Sangho LEE, Suwon-si (KR)

(73) Assignee: SAMSUNG ELECTRONICS CO., LTD., Suwon-si (KR)

(21) Appl. No.: 18/910,646

(22) Filed: Oct. 9, 2024

(30) Foreign Application Priority Data
Oct. 10, 2023 (KR) 10-2023-0134568

(51) Int. Cl. G10L 21/028

(52) U.S. Cl. CPC G10L 21/028

(57) ABSTRACT

An operation method of a data filtering module configured to communicate with a multi-speaker application module, includes: receiving a plurality of communication data from a plurality of external devices; generating filtered voice data from the plurality of communication data based on a filtering priority determined based on a number of voice data included in the plurality of communication data; and providing the filtered voice data to the multi-speaker application module.

### CROSS-REFERENCE TO RELATED APPLICATION

This application claims priority to Korean Patent Application No. 10-2023-0134568, filed on Oct. 10, 2023 in the Korean Intellectual Property Office, the content of which is incorporated by reference herein its entirety.

### BACKGROUND

The present disclosure relates to a central device communicating with a plurality of peripheral devices, and more specifically, to a central device communicating with a plurality of peripheral devices and an operation method of a data filtering module included in the central device.

In a multi-speaker communication system, a central device may receive voice data from a plurality of peripheral devices. However, when each of the plurality of peripheral devices simultaneously provides voice data to the central device, overlap may occur in a plurality of voice data.

When the overlap occurs in the plurality of voice data, it may be difficult to understand the contents of each the voice data. For example, when a multi-speaker communication system performs a sound recording function or conference function in which a plurality of speakers participate, it may become difficult to identify each speaker and/or content of the plurality overlapped of voice data.

### SUMMARY

Embodiments of the disclosure provide a central device that is formed to filter a plurality of voice data received from a plurality of peripheral devices, and an operation method of a data filtering module included in the central device.

According to an aspect of an example embodiment, an operation method of a data filtering module configured to communicate with a multi-speaker application module, includes: receiving a plurality of communication data from a plurality of external devices respectively; generating filtered voice data from the plurality of communication data based on a filtering priority determined based on a number of voice data included in the plurality of communication data; and providing the filtered voice data to the multi-speaker application module.

According to an aspect of an example embodiment, a central device includes: a priority management circuit configured to manage a filtering priority based on a number of voice data provided from a plurality of peripheral devices during a first unit filtering time; a data filtering circuit configured to generate filtered voice data by filtering the voice data provided from the plurality of peripheral devices based on the filtering priority; and a multi-speaker application module configured to perform a group recording function or a group communication function for the plurality of peripheral devices based on the filtered voice data.

According to an aspect of an example embodiment, an electronic device configured to receive first to n-th plurality of communication data, during a first to n-th connected isochronous group (CIG) event sequentially occurring respectively, through a first CIG including a plurality of connected isochronous streams (CISs), includes: a priority management circuit configured to manage a filtering priority including a plurality of priority values respectively corresponding to the plurality of CISs, based on a number of voice data included in each of the first to the n-th plurality of communication data; a data filtering circuit configured to filter first to n-th voice data from the first to the n-th plurality of communication data based on the filtering priority; and a multi-speaker application module configured to perform a group recording function or a group communication function for the plurality of CISs based on the first to the n-th voice data.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of a communication system according to one or more embodiments of the disclosure;

FIG. 2 is a block diagram of a configuration of the central device of FIG. 1 in more detail, according to one or more embodiments of the disclosure;

FIG. 3 is a timing diagram of the operation of the central device of FIG. 2, according to one or more embodiments of the disclosure;

FIG. 4 is a flowchart of the operation of the data filtering module for the communication data received during the unit filtering time, according to one or more embodiments of the disclosure;

FIG. 5 is a flowchart that shows operation S120 of FIG. 4 in detail, according to one or more embodiments of the disclosure;

FIG. 6 to FIG. 8 show a method for the data filtering module 120 to update the filtering priority FP, according to one or more embodiments of the disclosure;

FIG. 9 is a flowchart that shows S122 of FIG. 5 in detail, according to one or more embodiments of the disclosure;

FIG. 10 is a timing diagram illustrating the operation of the central device of FIG. 2 according to one or more embodiments;

FIG. 11 is a flowchart that shows the operation of the data filtering module according to one or more embodiments of FIG. 10;

FIG. 12 to FIG. 13 show the operation of the filtering notification circuit of FIG. 2 according to one or more embodiments;

FIG. 14 is a block diagram of the multi-speaker communication system of FIG. 1, implemented according to one or more embodiments;

FIG. 15 and FIG. 16 show a method for the data filtering module of FIG. 14 to receive the communication data from the plurality of CISs, according to one or more embodiments of the disclosure;

FIG. 17 shows the CIS event shown in FIG. 15 to FIG. 16, according to one or more embodiments of the disclosure;

FIG. 18 is a block diagram of the central device of FIG. 14 in more detail, according to one or more embodiments of the disclosure; and

FIG. 19 is a block diagram of the configuration and operation of the data filtering circuit and the data merging circuit of FIG. 18, according to one or more embodiments of the disclosure.

### DETAILED DESCRIPTION

Hereinafter, embodiments of the disclosure will be described clearly and in detail to the extent that a person of an ordinary skill in the technical field of disclosure can easily perform the disclosure. Details, such as detailed configurations and structures, are provided simply to facilitate an overall understanding of the embodiments of the disclosure. Therefore, modifications of the embodiments described in the disclosure can be performed by a person of an ordinary skill in the art without departing from the technical spirit and scope of the disclosure. Moreover, descriptions of well-known functions and structures are omitted for clarity and brevity. Components in the following drawings or detailed description may be connected to other components other than those shown in the drawing or described in the detailed description. The terms used in the specification are defined considering the functions of the disclosure and are not limited to specific functions. The definition of terms can be determined based on the details described in the detailed description.

Components described with reference to terms such as a driver or a block used in the detailed description may be implemented in the form of software, hardware, or a combination thereof. By way of example, software may be a machine code, firmware, an embedded code, and application software. For example, hardware may include an electrical circuit, an electronic circuit, at least one processor, at least one memory storing instructions, a computer, integrated circuit cores, a pressure sensor, an inertial sensor, a micro electro mechanical system (MEMS), a passive element, or a combination thereof.

Elements described as “modules” or “part” may be physically implemented by analog and/or digital circuits including one or more of a logic gate, an integrated circuit, a microprocessor, a microcontroller, a memory circuit, a passive electronic component, an active electronic component, and the like.

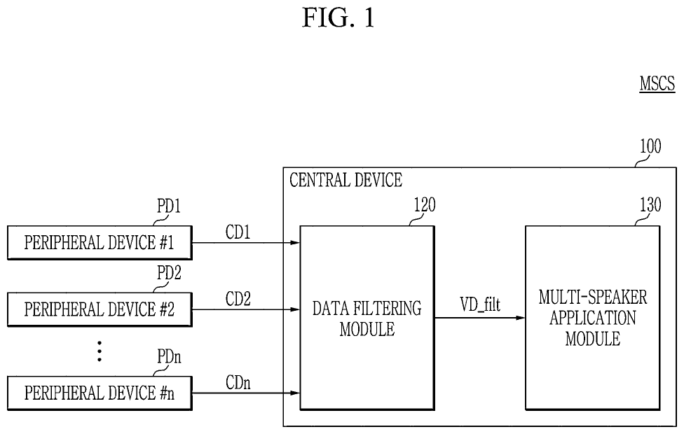

FIG. 1 is a block diagram of a communication system according to one or more embodiments of the disclosure. Referring to FIG. 1, a multi-speaker communication system (MSCS) may include a central device 100 and first to n-th peripheral devices PD1 to PDn.

The first to n-th peripheral devices PD1 to PDn may respectively output first communication data CD1 to n-th communication data DCn. In this case, communication data provided from a peripheral device of which user is speaking from among the first to n-th communication data CD1 to CDn may include voice data. For example, when a user of the first peripheral device PD1 speaks, first communication data CD1 may include voice data. Conversely, when a user of the second peripheral device PD2 does not speak, second communication data CD2 may not include voice data. That is, each of the first to n-th communication data CD1 to CDn may or may not include voice data.

The central device 100 may include a data filtering module 120 and a multi-speaker application module 130.

The data filtering module 120 may receive the first to n-th communication data CD1 to CDn and perform a data filtering operation. The data filtering module 120 may extract voice data included in the first to n-th communication data CD1 to CDn. The data filtering module 120 may filter the extracted voice data and output the filtered voice data VD_filt. In this case, the filtered voice data VD_filt may be voice data provided from one of the first to n-th peripheral device PD1 to PDn. That is, the filtered voice data VD_filt may be voice data included in communication data provided from one of the first to n-th peripheral device PD1 to PDn. A method for the data filtering module 120 to extract voice data from the first to n-th communication data CD1 to CDn and to filter the extracted voice data will be described in more detail with reference to the drawings.

In one or more embodiments, the data filtering module 120 may perform a data filtering operation every predetermined length of time. For example, the data filtering module 120 may generate one filtered voice data from a plurality of communication data provided in a first time period, and may generate one filtered voice data from a plurality of voice data provided in a second time period. In this case, time lengths of the first and second time period may be predetermined.

The multi-speaker application module 130 may receive the filtered voice data VD_filt from the data filtering module 120. The multi-speaker application module 130 may perform a multi-speaker application for the first to n-th peripheral device PD1 to PDn based on the filtered voice data VD_filt. For example, the multi-speaker application module 130 may perform a group recoding function or a group communication function for the first to n-th peripheral device PD1 to PDn based on the filtered voice data VD_filt. However, the scope of the disclosure is not limited thereto, and the multi-speaker application module 130 may perform any type of application in which the voice data provided from the first to n-th peripheral device PD1 to PDn, such as a group conference and the like.

In one or more embodiments, when the multi-speaker application module 130 performs the group recoding function, the multi-speaker application module 130 may record the filtered voice data VD_filt.

In one or more embodiments, when the multi-speaker application module 130 performs a group conversation or group conference function, the multi-speaker application module 130 may output filtered voice data VD_filt to the first to n-th peripheral device PD1 to PDn.

In one or more embodiments, the central device 100 may communicate with the first to n-th peripheral device PD1 to PDn based on one of various types of communication protocols such as Bluetooth, Wi-Fi, ultra-wide band (UWB), radio frequency identification (RFID), and the like. However, hereinafter, one or more embodiments in which the central device 100 communicates with the first to n-th peripheral device PD1 to PDn via Bluetooth will be representatively described. However, the scope of the disclosure is not limited to a communication method between the central device 100 and the first to n-th peripheral device PD1 to PDn. For example, the central device 100 may communicate with the first to n-th peripheral device PD1 to PDn based on any type of communication protocol.

In one or more embodiments, the first to n-th peripheral device PD1 to PDn each may be any type of electronic device that provides voice data. For example, each of the first to n-th peripheral device PD1 to PDn may be one of various types of electronic devices such as a microphone, an earphone, a speaker, a headset, a laptop, a smartphone, a tablet PC, and the like.

In one or more embodiments, the central device 100 may be any type of electronic device that filters received voice data. For example, the central device 100 may be one of various types of electronic devices such as a laptop, a smartphone, a tablet PC, and the like.

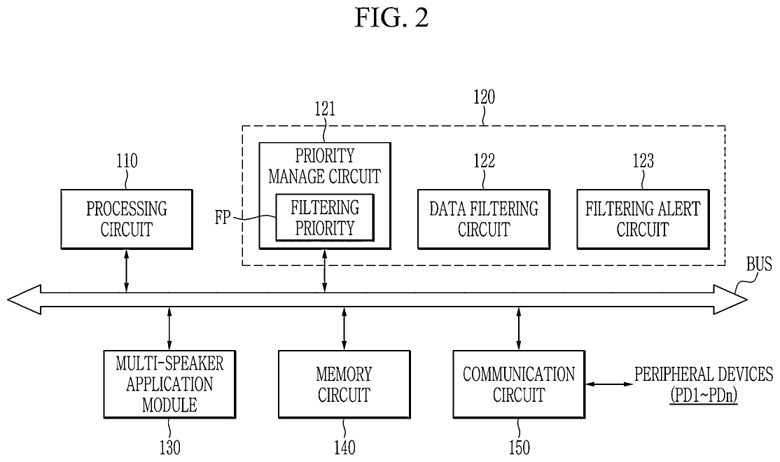

FIG. 2 is a block diagram of a configuration of the central device of FIG. 1 in more detail. Referring to FIG. 1 and FIG. 2, the central device 100 may include a processing circuit 110, a data filtering module 120, a multi-speaker application module 130, a memory circuit 140, and a communication circuit 150. The processing circuit 110, the data filtering module 120, the multi-speaker application module 130, the memory circuit 140, and the communication circuit 150 may be connected to each other through a bus BUS.

The processing circuit 110 may control the entire operation of the central device 100. For example, the processing circuit 110 may drive operating system demands for the operation of the data filtering module 120, the multi-speaker application module 130, the memory circuit 140, and the communication circuit 150.

The data filtering module 120 may include a priority management circuit 121, a data filtering circuit 122, and a filtering notification circuit 123.

The priority management circuit 121 may store filtering priority (FP). The filtering priority FP may include a first priority value to an n-th priority value respectively corresponding to the first to n-th peripheral device PD1 to PDn.

The priority management circuit 121 may manage the filtering priority FP. For example, the priority management circuit 121 may update the first to n-th priority values included in the filtering priority FP. That is, the priority management circuit 121 may increase or decrease the first to n-th priority values included in the filtering priority FP.

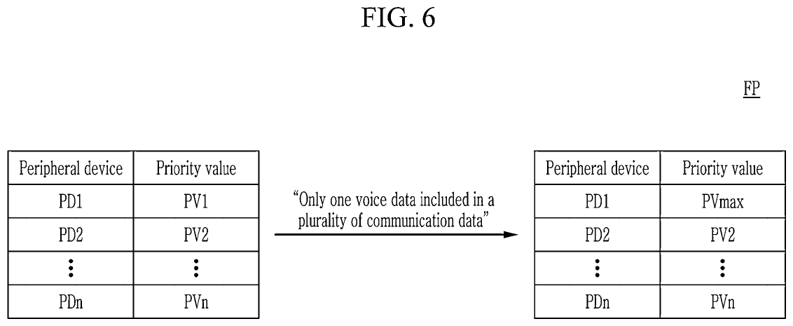

In one or more embodiments, the priority management circuit 121 may update the filtering priority FP based on the number of voice data included in the first to n-th communication data CD1 to CDn. A method for the priority management circuit 121 to manage the filtering priority FP will be described in more detail with reference to FIG. 6 to FIG. 11.

The data filtering circuit 122 may filter-out voice data provided from one of the first to n-th peripheral device PD1 to PDn based on the filtering priority FP. For example, the data filtering circuit 122 may filter one or more voice data included in the first to n-th communication data CD1 to CDn based on the filtering priority FP, and may generate filtered voice data VD_filt. In this case, the filtered voice data VD_filt may correspond to voice data included in one of the first to n-th communication data CD1 to CDn. That is the data filtering circuit 122 may filter-out the filtered voice data VD_filt from the first to n-th communication data CD1 to CDn.

The filtering notification circuit 123 may notify the operation of the data filtering circuit 122 to the first to n-th peripheral device PD1 to PDn.

In one or more embodiments, as the data filtering circuit 122 operates, the filtering notification circuit 123 may notify that voice data other than the filtered voice data VD_filt among the voice data included in the first to n-th communication data CD1 to CDn is not provided to the multi-speaker application module 130. However, the scope of the disclosure is not limited thereto.

In one or more embodiments, as the data filtering circuit 122 does not operate, the filtering notification circuit 123 may notify that any transmitted voice data can be provided to the multi-speaker application module 130 when any device among the first to n-th peripheral device PD1 to PDn transmit the voice data. However, the scope of the disclosure is not limited thereto.

The multi-speaker application module 130 may receive the filtered voice data VD_filt from the data filtering circuit 122. The operation of the multi-speaker application module 130 is similar to the operation descried above with reference to FIG. 1, and therefore a detailed description will be omitted.

In one or more embodiments, a part of the data filtering module 120 and the multi-speaker application module 130 may be implemented by software stored in the memory circuit 140 and driven by the processing circuit 110. However, the scope of the disclosure is not limited thereto, and each of the data filtering module 120 and the multi-speaker application module 130 may be implemented with hardware, software, or a combination thereof.

The communication circuit 150 may communicate with the first to n-th peripheral device PD1 to PDn. For example, the communication circuit 150 may transmit the first to n-th communication data CD1 to CDn transmitted from the first to n-th peripheral device PD1 to PDn to the data filtering module 120. However, the scope of the disclosure is not limited thereto.

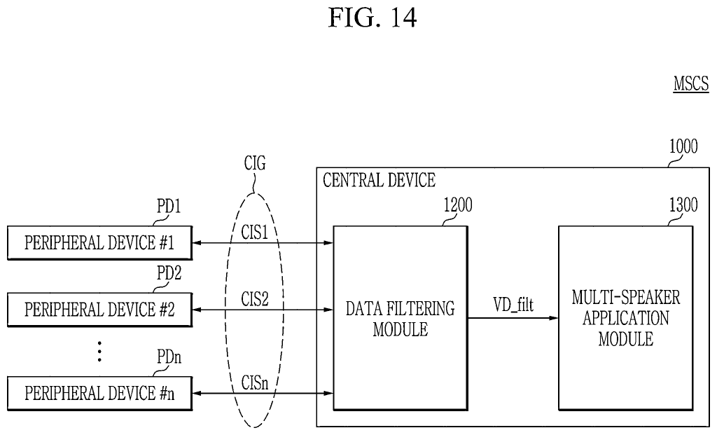

In one or more embodiments, the communication circuit 150 may communicate with the first to n-th peripheral device PD1 to PDn based on the Bluetooth protocol. For example, the communication circuit 150 may communicate with each of the first to n-th peripheral device PD1 to PDn based on the Bluetooth protocol-based connected isochronous stream (CIS). In this case, a plurality of CISs respectively established between the first to n-th peripheral device PD1 to PDn and the communication circuit 150 may form a single connected isochronous group (CIG). One or more embodiments in which the communication circuit 150 communicates with the first to n-th peripheral device PD1 to PDn based on the Bluetooth protocol will be described in more detail with reference to FIG. 14 to FIG. 19.

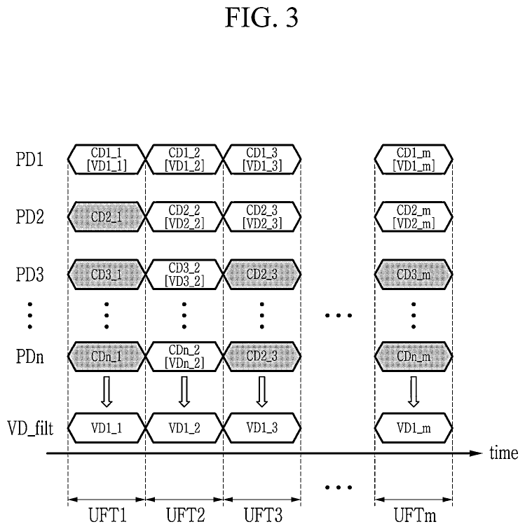

FIG. 3 is a timing diagram of the operation of the central device of FIG. 2. Referring to FIG. 1 to FIG. 3, the central device 100 may receive a plurality of communication data CD from the first to n-th peripheral device PD1 to PDn for every unit filtering time UFT. Hereinafter, for a more concise description, communication data received by the central device 100 from a j-th peripheral device PDj during an i-th unit filtering time UFTi will be referred to as CDj_i. For example, the central device 100 may receive communication data CD2_1 from the second peripheral device PD2 for a first unit filtering time UFT1, and the central device 100 may receive communication data CDn_m from the n-th peripheral device PDn for an m-th unit filtering time UFTm. However, the scope of the disclosure is not limited thereto.

The plurality of communication data CD may or may not include voice data VD. For example, the communication data CD shown without shading in FIG. 3 may include voice data VD, and the communication data CD shown in gray shading may not include voice data VD.

That is, some of the communication data CD1_1 to CDn_1 received during the first unit filtering time UFT1 may include voice data, and some may not include voice data. For example, the communication data CD1_1 among the communication data CD1_1 to CDn_1 received for the first unit filtering time UFT1 may include voice data and the communication data CD2_1 to CDn_1 may not include voice data. Hereinafter, for a more concise description, voice data included in communication data CDj_i will be referred to as VDj_i.

The data filtering module 120 may perform data filtering operations for each unit filtering time UFT. That is, the data filtering module 120 may filter out one voice data from one or more voice data included in the plurality of communication data received during the unit filtering time UFT. For example, the priority management circuit 121 may update filtering priority FP based on the number of voice data included in the communication data received for a unit filtering time UFT. The data filtering circuit 122 may filter-out one voice data from one or more voice data included in the communication data received during the unit filtering time UFT based on the updated filtering priority FP.

In one or more embodiments, the data filtering module 120 may filter communication data CD1 to CDn-1 received during the first unit filtering time UFT1 and output voice data VD1_1 provided from the first peripheral device PD1. In this case, the filtered voice data VD_filt corresponding to the first unit filtering time UFT1 may be voice data VD1_1.

In one or more embodiments, the data filtering module 120 may filter communication data CD1_2 to CDn_2 received during the second unit filtering time UFT2 and output voice data VD1_2 provided from the first peripheral device PD1. In this case, the filtered voice data VD_filt corresponding to the second unit filtering time UFT2 may be voice data VD1_2. In such a way, the data filtering module 120 may be able to perform data filtering operations for each of the third to m-th unit filtering time.

In one or more embodiments, a length of the unit filtering time may be longer than 5 ms and shorter than 20 ms. However, the scope of the disclosure is not limited thereto. For example, the length of the unit filtering time may be longer than 5 ms and shorter than 4 sec.

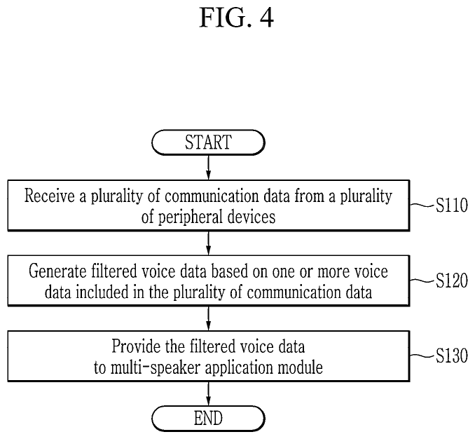

FIG. 4 is a flowchart of the operation of the data filtering module for the communication data received during a unit filtering time. Hereinafter, for a more concise description, the operation of the data filtering module 120, which outputs one filtered voice data from a plurality of communication data received during one unit filtering time, will be representatively described.

Referring to FIG. 1 to FIG. 4, in S110, the data filtering module 120 may receive a plurality of communication data from a plurality of peripheral devices. For example, the data filtering module 120 may receive the first to n-th communication data CD1 to CDn from the first to n-th peripheral device PD1 to PDn.

In S120, the data filtering module 120 may generate filtered voice data VD_filt based on one or more voice data included in the plurality of communication data. For example, the data filtering module 120 may generate filtered voice data VD_filt by filtering one or more voice data included in the first to n-th communication data CD1 to CDn. In this case, the filtered voice data VD_filt may be one of voice data included in the first to n-th communication data CD1 to CDn.

In S130, the data filtering module 120 may provide the filtered voice data VD_filt to the multi-speaker application module 130. In this case, the multi-speaker application module 130 may execute the multi-speaker application based on the filtered voice data VD_filt. For example, the multi-speaker application module 130 may perform a group recoding function or a group communication function for the first to n-th peripheral device PD1 to PDn based on the filtered voice data VD_filt.

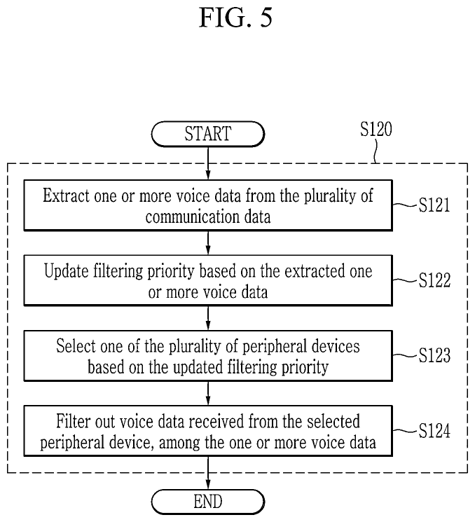

FIG. 5 is a flowchart that shows operation S120 of FIG. 4 in detail. Referring to FIG. 1 to FIG. 5, S120 may include S121 to S124.

In S121, the data filtering module 120 may extract one or more voice data from the plurality of communication data. For example, the data filtering module 120 may extract voice data from each of the first to n-th communication data CD1 to CDn.

In S122, the data filtering module 120 may update filtering priority FP from the one or more extracted voice data. For example, the priority management circuit 121 may update the filtering priority FP based on the number of voice data extracted from the first to n-th communication data CD1 to CDn. A detailed method in which the data filtering module 120 updates the filtering priority FP based on the number of extracted voice data will be described in detail with reference to FIG. 6 to FIG. 9.

In S123, the data filtering module 120 may select one of the plurality of peripheral devices based on the updated filtering priority FP. For example, the data filtering circuit 122 may select a peripheral device with the highest priority value among the first to n-th peripheral device PD1 to PDn.

In S124, the data filtering module 120 may filter-out voice data provided from the selected peripheral device among one or more voice data. For example, the data filtering circuit 122 may filter-out voice data provide from the peripheral device selected in S123 among voice data extracted in S121.

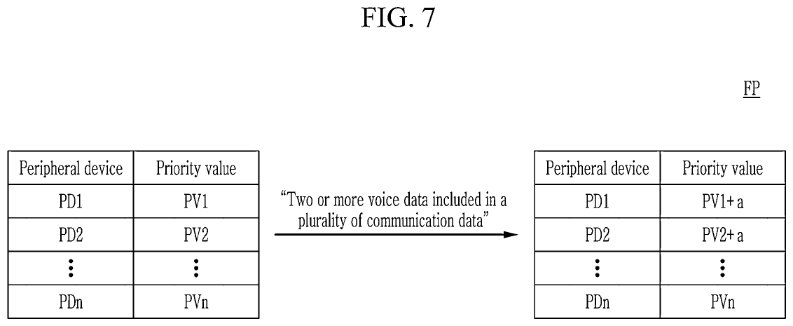

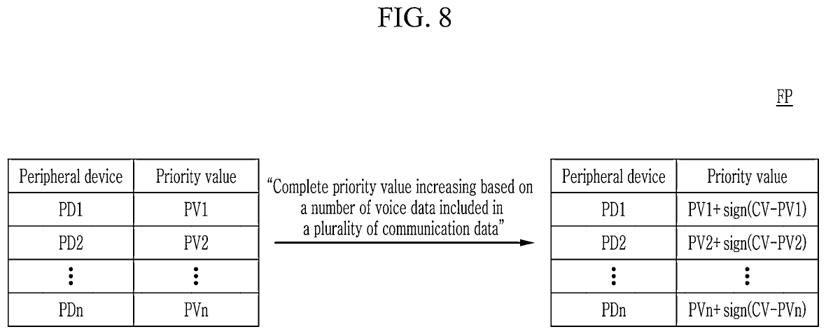

FIGS. 6, 7, and FIG. 8 show a method for the data filtering module 120 to update the filtering priority FP. Hereinafter, referring to FIG. 6 and FIG. 7, one or more embodiments in which the data filtering module 120 updates the filtering priority FP according to the number of voice data received during single unit filtering time will be described; and referring to FIG. 8, one or more embodiments in which the data filtering module 120 adjusts filtering priority FP to prevent plurality of priority values from becoming the same will be described. In addition, for a more concise description, one or more embodiments in which the filtering priority FP updates a first to n-th priority value PV1 to PVn corresponding to each of the first to n-th peripheral devices PD1 to PDn will be representatively described. However, the scope of the disclosure is not limited thereto.

First, referring to FIG. 1 to FIG. 5 and FIG. 6, when only one voice data is included in the plurality of communication data, the priority management circuit 121 may increase a priority value corresponding to the one voice data to an upper limit value PVmax. That is, the priority management circuit 121 may increase the priority value corresponding to the peripheral device that provided communication data including voice data to the upper limit value PVmax. For example, the data filtering module 120 may receive communication data CD1_1 to CDn_1 from the first to n-th peripheral device PD1 to PDn respectively during the first unit filtering time UFT1. In this case, only the communication data CD1_1, among the communication data CD1_1 to CDn_1, may include voice data (i.e., voice data VD1_1). In this case, priority management circuit 121 may increase the first priority value PV1 corresponding to the first peripheral device PD1 to the upper limit value PVmax.

Next, referring to FIG. 1 to FIG. 5 and FIG. 7, when two or more voice data are included in the plurality of communication data, the priority management circuit 121 may increase priority values corresponding to the two or more voice data by a simultaneous speaking priority value “a”. That is, the priority management circuit 121 may increase a priority value corresponding to each of two or more peripheral devices providing the communication data including voice data by the simultaneous speaking priority value “a”. For example, during the third unit filtering time UFT3, the data filtering module 120 may receive communication data CD1_3 to CDn_3 from the first to n-th peripheral device PD1 to PDn respectively. In this case, the communication data CD1_3 and the communication data CD2_3 may include voice data. In this case, priority values corresponding to the first and second peripheral device PD1 and PD2 (i.e., first and second priority values PV1 and PV2) may be increased by the simultaneous speaking priority value “a”.

In one or more embodiments, when the number of voice data included in the plurality of communication data is 0, the priority management circuit 121 may not update the first to n-th priority values PV1 to PVn. However, the scope of the disclosure is not limited thereto, as described in detail with reference to FIG. 8 below, the priority management circuit 121 may further adjust the first to n-th priority values PV1 to PVn in a direction of converging to a convergence value.

Referring to FIG. 1 to FIG. 5 and FIG. 8, after the increase of the priority value based on the number of voice data included in the plurality of communication data is completed, the data filtering module 120 may adjust each of the priority values for converging to the convergence value CV. For example, the priority management circuit 121 may decrease a priority value greater than the convergence value CV among the first to n-th priority values PV1 to PVn by 1 and may increase a priority value smaller than the convergence value CV among the first to n-th priority values PV1 to PVn by 1. However, the scope of the disclosure is not limited thereto, and the data filtering module 120 may adjust each priority value by an arbitrary size in a direction that converges to the convergence value CV.

In one or more embodiments, when the priority values are respectively adjusted to the direction of converging to the convergence value CV, after the plurality of unit filtering times elapses, the probability that two or more of the first to n-th priority values PV1 to PVn identically have the largest value may be minimized. In this case, the probability that the two or more priority values corresponds to the highest priority value among the first to n-th priority values PV1 to PVn may be minimized.

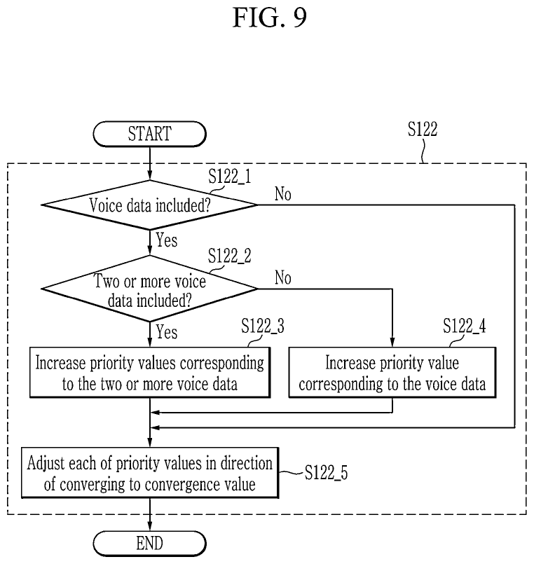

FIG. 9 is a flowchart that shows operation S122 of FIG. 5 in detail. Referring to FIG. 1 to FIG. 9, operation S122 may include the following operations S122_1 to S122_5.

In S122_1, the data filtering module 120 may determine whether voice data is included in the plurality of received communication data. For example, when S110 is performed during the first unit filtering time UFT1 (i.e., when S120 is performed for the communication data CD1_1 to CDn_1), the data filtering module 120 may determine whether one or more communication data CD1_1 to CDn_1 include voice data.

When it is determined that the voice data is included in S122_1, the following S122_2 may be performed.

In S122_2, the data filtering module 120 may determine whether two or more voice data are included in the received communication data. That is, the data filtering module 120 may determine whether a plurality of voice data are included in the plurality of received communication data.

When it is determined that two or more voice data are included in S122_2, the following S122_3 may be performed. On the other hand, when it is determined that the two or more voice data are not included in S122_2 (i.e., it is determined that only one voice data is included), the following S122_4 may be performed.

In S122_3, the data filtering module 120 may increase priority values corresponding to the two or more voice data. That is, as described with reference to FIG. 7, the data filtering module 120 may increase priority values corresponding to each plurality of peripheral devices that provided communication data including voice data. For example, when S110 is performed during the third unit filtering time UFT3, the priority management circuit 121 may increase priority values respectively corresponding to peripheral devices (e.g., the first and second peripheral devices PD1 and PD2) that provide communication data including voice data (e.g., communication data CD1_3 and CD2_3).

In one or more embodiments, in S122_3, the priority management circuit 121 may increase the priority value of each of the peripheral devices that provide voice data by the simultaneous speaking priority value “a”. For example, the priority management circuit 121 may increase the priority values corresponding to the first and second peripheral devices PD1 and PD2 by the simultaneous speaking priority value “a”.

In S122_4, the data filtering module 120 may increase a priority value corresponding to the voice data. That is, as described with reference to FIG. 6, the data filtering module 120 may increase priority value corresponding to a peripheral device that provided communication data including voice data. For example, when S110 is performed during the first unit filtering time UFT1, the priority management circuit 121 may increase a priority value corresponding to a peripheral device (e.g., the first peripheral device PD1) that provides the communication data including voice data (e.g., communication data CD1_1).

In one or more embodiments, in S122_4, the priority management circuit 121 may increase the priority value for the peripheral device that provide voice data to upper limit PVmax. For example, the priority management circuit 121 may increase the priority value corresponding to the first peripheral device PD1 to the upper limit PVmax.

When it is determined that no voice data is included in S122_1, the following S122_5 may be performed.

In S122_5, the data filtering module 120 may adjust the priority values in a direction of converging to a convergence value CV as previously described with reference to FIG. 8. For example, the priority management circuit 121 may decrease priority values that are greater than the convergence value CV and increase priority values that are smaller than the convergence value CV among the priority values included in the filtering priority FP.

That is, when it is determined that the voice data is not included in S122_1, the data filtering module 120 may adjust the priority values included in the filtering priority FP to a direction of converging to the convergence value CV.

For a more concise description, one or more embodiments in which S122_5 is performed after S122_3 or S122_4 is performed is representatively illustrated in FIG. 6, but the scope of the disclosure is not limited thereto. For example, S122_5 may be performed only when it is determined that the voice data is not included in S122_1.

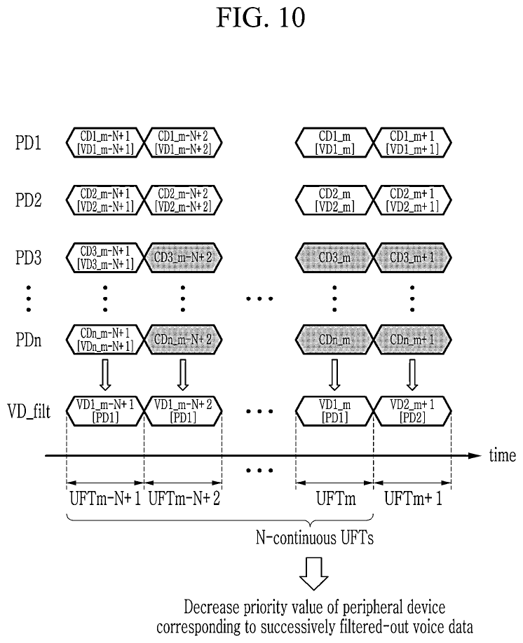

FIG. 10 is a timing diagram illustrating the operation of the central device of FIG. 2 according to one or more embodiments. Referring to FIG. 1 to FIG. 10, a plurality of filtered voice data generated for a plurality of consecutive unit filtering times may correspond to a single peripheral device. For example, a plurality of filtered voice data VD_filt generated responding to a plurality of communication data received during an (m-N+1)-th to m-th unit filtering time UFTm-N+1 to UFTm may be voice data provided from the first peripheral device PD1. For example, the filtered voice data VD_filt generated based on the communication data received during the (m-N+1)-th unit filtering time UFTm-N+1 may be voice data VD1_m-N+1, and similarly, the filtered voice data VD_filt generated based on the communication data received during the m-th unit filtering time UFTm may be voice data VD1_m.

That is, all of the plurality of filtered voice data VD_filt generated in response to the a plurality of communication data received during ‘N’ consecutive unit filtering times may be voice data provided from a single peripheral device (e.g., the first peripheral device PD1). In this case, the priority management circuit 121 may decrease a priority value of a peripheral device corresponding to consecutively filtered-out voice data. For example, the priority management circuit 121 may decrease a priority value (i.e., the first priority value PV1) corresponding to the first peripheral device PD1.

In one or more embodiments, the priority management circuit 121 may reduce the priority value of the peripheral device corresponding to continuously filtered out voice data to a lower limit value. For example, the priority management circuit 121 may reduce the first priority value PV1 to the lower limit value.

In one or more embodiments, the lower limit value may refer to a lower limit of each priority value included in filtering priority FP. For example, the lower limit may be 0. However, the scope of the disclosure is not limited thereto.

In one or more embodiments, when the first priority value PV1 is decreased to the lower limit value, at least one of the second to n-th priority values may have a value higher than the first priority value PV1. In this case, although both of the communication data CD1_m+1 and the communication data CD2_m+1 received during the (m+1)-th unit filtering time UFTm+1 include voice data, voice data included in the communication data CD2_m+1 may be filtered-out as filtered voice data VD_filt.

That is, according to one or more embodiments of the disclosure, even though the first peripheral device PD1 continuously provide voice data, exclusive speaking of the first peripheral device PD1 can be prevented. For example, when the filtered voice data VD_filt for the ‘N’ consecutive unit filtering times corresponds to the voice data provided from the first peripheral device PD1, filtered voice data VD_filt for the next unit filtering time may be voice data provided from another peripheral device. Accordingly, the phenomenon in which only voice data provided from one peripheral device is continuously provided to a multi-speaking application module can be prevented.

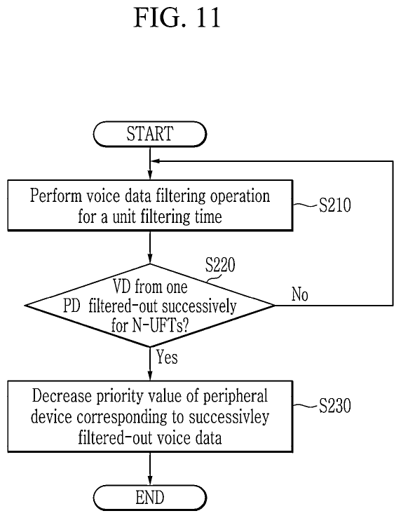

FIG. 11 is a flowchart that shows the operation of the data filtering module according to one or more embodiments of FIG. 10. Referring to FIG. 1 to FIG. 11, the data filtering module 120 may perform a voice data filtering operation for a unit filtering time in S210. For example, the data filtering module 120 may filter-out one voice data by filtering a plurality of communication data received during a single unit filtering time.

In S220, the data filtering module 120 may determine whether voice data is consecutively filtered-out during ‘N’ unit filtering times from one peripheral device. For example, when the voice data filtering operation for the m-th unit filtering time is performed in S210, the data filtering module 120 may determine whether all of the plurality of filtered voice data VD_filt for the (m-N+1)-th to m-th unit filtering times are voice data provided from one peripheral device.

In one or more embodiments, when it is determined that the voice data is not continuously filtered-out during the N unit filtering times from one peripheral device in S220, the following S210 may be performed. That is, until the voice data from one peripheral device is continuously filtered-out during the N unit filtering times, the data filtering module 120 may repeatedly perform the voice data filtering operation.

In one or more embodiments, when it is determined that the voice data is continuously filtered-out during the N unit filtering times from one peripheral device in S220, the following S230 may be performed.

In S230, the data filtering module 120 may reduce a priority value of the peripheral device corresponding to the continuously filtered-out voice data. For example, the priority management circuit 121 may reduce a priority value of a peripheral device that provided voice data determined to be continuously filtered-out during the N unit filtering times in S220 to the lower limit value.

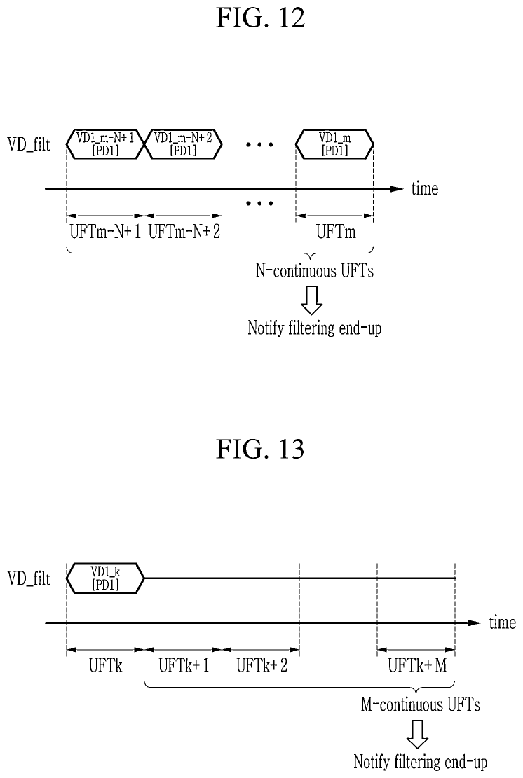

FIG. 12 to FIG. 13 show the operation of the filtering notification circuit of FIG. 2 according to one or more embodiments. First, referring to FIG. 1 to FIG. 12, as similar to FIG. 10 and referring to FIG. 11, when all of the plurality of filtered voice data VD_filt for the (m-N+1)-th to m-th unit filtering times are voice data provided from the first peripheral device PD1, the data filtering module 120 may reduce the first priority value PV1 to the lower limit value. In this case, since the first priority value PV1 is reduced to the lower limit value, voice data provided from the second to n-th peripheral devices PD2 to PDn may be filtered out. In this case, the filtering notification circuit 123 may notify that the voice data provided from other peripheral devices can be filtered out.

That is, when voice data from one peripheral device is continuously filtered out during the N unit filtering times, the filtering notification circuit 123 may provide notification to indicate filtering end-up to each of the first to n-th peripheral device PD1 to PDn.

In one or more embodiments, the priority management circuit 121 may include a counter that counts the number of times voice data provided from a single peripheral device has been continuously filtered out over a plurality of unit filtering time (i.e., the number of times continuously determined as filtered voice data VD_filt). In this case, the counter included in the priority management circuit 121 may be initialized as the peripheral device corresponding to the filtered voice data VD_filt is changed or may be initialized as S230 is performed. However, the scope of the disclosure is not limited thereto. For example, the priority management circuit 121 may include a timer that determines whether voice data provided from a single peripheral device is continuously filtered out for a predetermined length of time. In other words, the scope of the disclosure will not be limited to the specific way in which S220 is performed.

Then, referring to FIG. 1 to FIG. 9 and FIG. 13, for M continuous unit filtering times after a k-th unit filtering time UFTk, the central device 100 may not be provided with voice data. For example, during a (k+1)-th to (k+M)-th unit filtering times UFTk+1 to UFTk+M, communication data received at the central device 100 may not include voice data. In this case, no filtered voice data VD_filt may be generated for the (k+1)-th unit filtering time UFTk+1 to the (k+M)-th unit filtering time UFTk+M.

In one or more embodiments, when no voice data is continuously received during ‘M’ unit filtering times, the data filtering module 120 may terminate voice data filtering. In this case, the filtering notification circuit 123 may notify that voice data is not being received and any voice data will be provided to the multi-speaker application module 130 no matter which peripheral device transmits voice data.

That is, when no voice data is continuously received during the M unit filtering times, the filtering notification circuit 123 may provide a notification indicating filtering end-up to the first to n-th peripheral device PD1 to PDn, respectively.

In one or more embodiments, as described with referring FIG. 12 to FIG. 13, when the data filtering module 120 terminates the filtering operation, the priority management circuit 121 may initialize the first to n-th priority values PV1 to PVn respectively. For example, the priority management circuit 121 may change each of the first to n-th priority values PV1 to PVn to the lower limit value (e.g., 0) or change them to the convergence value CV. However, the scope of the disclosure may not be limited to the specific method of initializing each of the first to n-th priority values PV1 to PVn) by the priority management circuit 121. For example, the priority management circuit 121 may initialize the first priority value PV1 to the n-th priority value PVn with different value each other.

In one or more embodiments, the priority management circuit 121 may initialize the first priority value PV1 to the n-th priority value PVn to different values based on the order in which the corresponding peripheral devices are connected to the central device 100. In this case, although the plurality of peripheral devices provide voice data during a single unit filtering time, the priority values respectively corresponding to the plurality of peripheral devices may be different each other, and thus voice data provided from one peripheral device may be filtered out. However, the scope of the disclosure is not limited thereto.

FIG. 14 is a block diagram of the multi-speaker communication system of FIG. 1, implemented according to one or more embodiments. Referring to FIG. 1 to FIG. 14, a multi-speaker communication system MSCS may include a first peripheral device PD1 to a n-th peripheral device PDn and a central device 1000.

The central device 1000 may include a data filtering module 1200 and a multi-speaker application module 1300. The configuration and functions of the data filtering module 1200 and multi-speaker application module 1300 are similar to those previously described with reference to FIG. 1, and thus will not described in further detail.

The central device 1000 may communicate with each of the first to n-th peripheral device PD1 to PDn based on a low energy (LE) audio-based Bluetooth protocol. For example, different connected isochronous streams (CIS) may be established between the central device 100 and the first to n-th peripheral device PD1 to PDn. Hereinafter, for a more concise description, a CIS established between the central device 100 and an i-th peripheral device PDi may be referred to as a i-th CIS. For example, a first CIS CIS1 may be established between the central device 100 and the first peripheral device PD1, and a second CIS CIS2 may be established between the central device 100 and the second peripheral device PD2.

The central device 1000 may receive communication data during different CIS events that respectively correspond to the first to n-th CIS CIS1 to CISn. For example, the central device 1000 may receive communication data provided through the first CIS CIS1 while a first CIS event is occurred, and may receive communication data provided through a second CIS CIS2 while a second CIS event is occurred.

In one or more embodiments, one CIS event may include a plurality of CIS subevents. For example, the first CIS event may include a plurality of first CIS subevents, and the second CIS event may include a plurality of second CIS subevents. However, hereinafter, for a more concise description, “CIS subevent” may also be referred to as “subevent”.

In one or more embodiments, the central device 1000 may receive communication data while each of the plurality of CIS subevents is occurred. For example, the central device 1000 may receive a part of communication data for each CIS subevent.

In one or more embodiments, a PDU (protocol data unit) corresponding to a portion of voice data VD may be transmitted on some of the plurality of CIS subevents. For example, the first peripheral device PD1 may provide voice data to the central device 1000 by sequentially and respectively providing a plurality of PDUs during the plurality of CIS subevent included in the first CIS event.

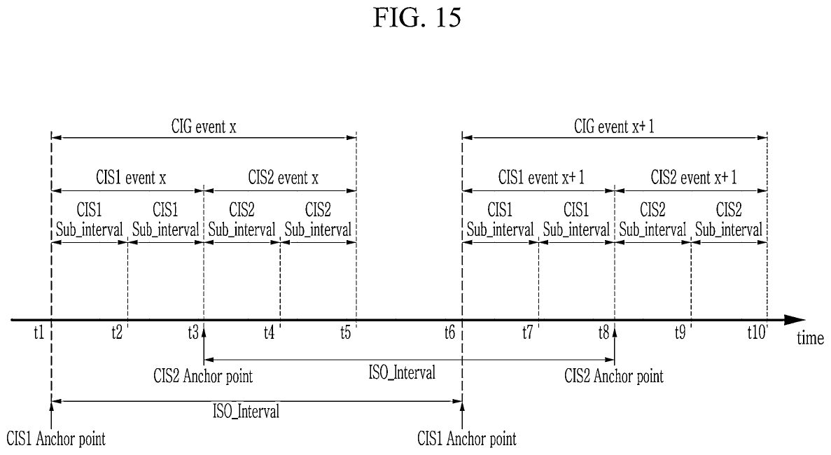

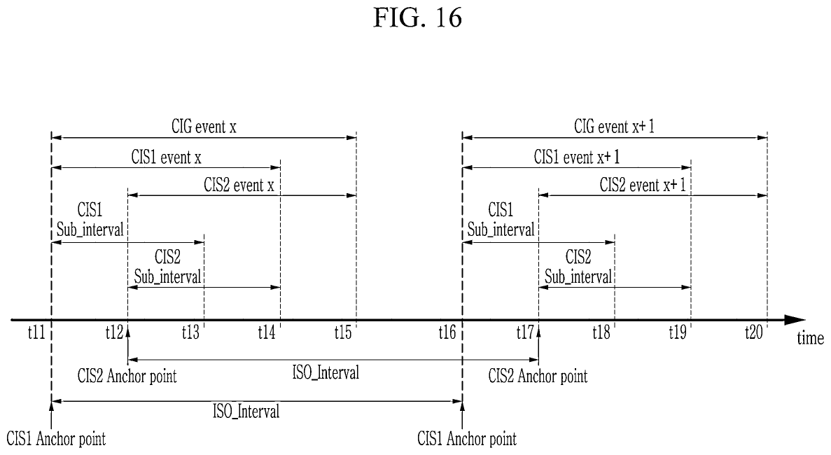

The first to n-th CIS CIS1 to CISn may form one connected isochronous group CIG. For example, the first CIS1 to the n-th CIS CISn may share an isochronous (ISO) interval of same length. In this case, the central device 1000 may receive communication data from the first CIS CIS1 to the n-th CIS CISn in a sequential scheme, or may receive communication data in an interleaving scheme. The operation of the central device 1000, which receives communication data in a sequential scheme from the first to n-th CIS CIS1 to CISn, is described below referring to FIG. 15, and the operation of the central device 1000 receiving communication data in an interleaving scheme will be described in more detail with reference to FIG. 16.

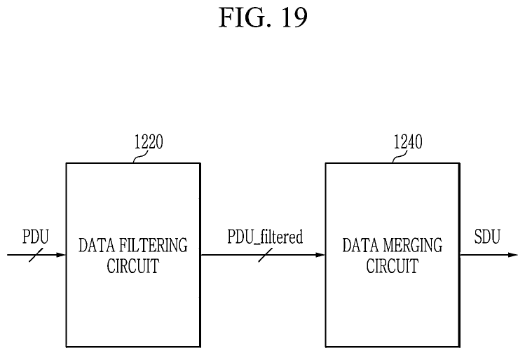

The data filtering module 1200 may generate filtered voice data VD_filt based on the PDUs included in the communication data received through the first to n-th CIS CIS1 to CISn. A method for the data filtering module 1200 to generate the filtered voice data VD_filt based on the PDUs will be described in more detail with reference to FIG. 19.

FIG. 15 and FIG. 16 show a method for the data filtering module of FIG. 14 to receive the communication data from the plurality of CISs. Hereinafter, one or more embodiments in which the data filtering module 1200 receives communication data using a sequential scheme will be described with reference to FIG. 15, and one or more embodiments in which the data filtering module 1200 receives communication data using an interleaving scheme will be described with reference to FIG. 16. In addition, hereinafter, for more a concise description, one or more embodiments in which the data filtering module 1200 receive communication data from two peripheral devices, and two CIS subevents are included in one CIS event will be representatively described. That is, hereinafter, one or more embodiments in which n is 2 and a number of subevents (NSE) is 2 will be representatively described. However, the scope of the disclosure is not limited thereto.

First, referring to FIG. 14 and FIG. 15, an x-th CIG event (hereinafter, referred to as a “CIG event x”) may occur between a first time point t1 and a fifth time point t5. The CIG event x may include a CIS for the first CIS CIS1 event (hereinafter, referred to as a “CIS1 event x”), and a CIS event for the second CIS CIS2 (hereinafter, referred to as a “CIS2 event x”).

For example, the CIS1 event x may occur between the first time point t1 and a third time point t3, and the CIS2 event x may occur between the third time point t3 and the fifth time point t5. That is, the CIS1 event x and the CIS2 event x may sequentially occur.

The CIS1 event x may include a plurality of subintervals for the first CIS CIS1 (hereinafter, referred to as “CIS1 Sub_interval”). For example, the CIS1 Sub_intervals may be included between the first time point t1 and the second time point t2, and between the second time point t2 and the third time point t3. In this case, each CIS1 Sub_interval may include a CIS subevent for the first CIS CIS1.

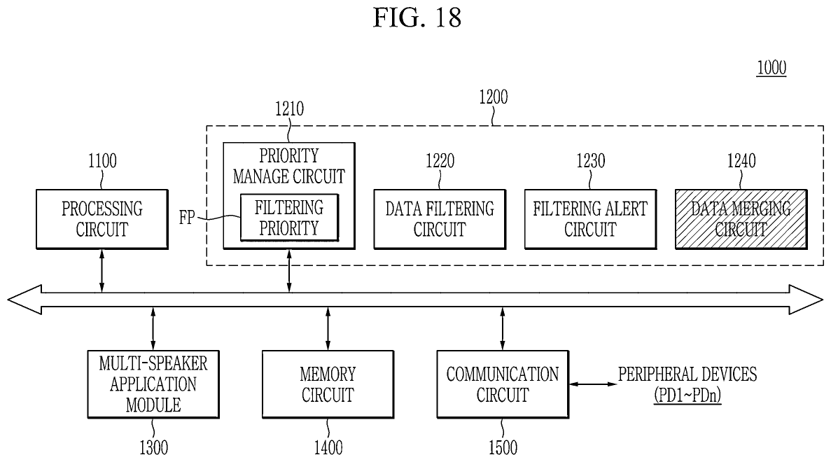

Similarly, the CIS2 event x may include a plurality of subintervals for the second CIS CIS2 (hereinafter, referred to as CIS2 Sub_interval). For example, the CIS2 Sub_intervals may be included between the third time point t3 and a fourth time point t4, and between the fourth time point t4 and the fifth time point t5, respectively. In this case, each CIS2 Sub_interval may include a CIS subevent for the second CIS CIS2. The CIS subevent will be described later in detail with reference to FIG. 18.

In one or more embodiments, the CIG event may include a plurality of CIS events respectively corresponding to a plurality of peripheral devices connected to the central device 1000. In this case, the plurality of CIS events may correspond to the different peripheral device each other.

In one or more embodiments, the CIS event may refer to a time period in which the central device 1000 and the peripheral devices can exchange communication data.

In one or more embodiments, the CIS subevent may refer to a time period in which the central device 1000 and the peripheral devices can exchange communication data once.

In one or more embodiments, a peripheral device may transmit communication data of approximately 200 bytes to the central device 1000 during a single CIS subevent. However, the scope of the disclosure is not limited thereto.

An (x+1)-th CIG event (hereinafter, referred to as a CIG event x+1) may occur at a sixth time point t6 after the ISO interval has elapsed from the first time point t1. The CIG event x+1 may include an CIS event for the first CIS CIS1 (hereinafter, referred to as a CIS1 event x+1) and a CIS event for the second CIS CIS2 (hereinafter, referred to as a CIS2 event x+1). Detailed descriptions for CIS events included in the CIG event x+1 are similar to the descriptions for the CIG event x, and therefore no further detailed description is provided.

Anchor points for the first CIS CIS1 (hereinafter, referred to as CIS1 Anchor point) may be arranged at time points when the CIS events for the first CIS CIS1 (i.e., CIS1 event x and CIS1 event x+1) start (i.e., first time t1 and sixth time t6). In this case, an interval between the CIS1 anchor points may be an ISO interval.

Similarly, anchor points for the second CIS CIS2 (hereinafter, referred to as CIS2 Anchor point) may be arranged at time points when the CIS events for the second CIS CIS2 (i.e., CIS2 event x and CIS2 event x+2) start (i.e., third time t3 and eighth time t8). In this case, an interval between the CIS2 anchor points may be an ISO interval.

In one or more embodiments, the interval between the CIS1 Anchor points and the interval between the CIS2 Anchor points may be equal to each other.

Next, referring to FIG. 14 and FIG. 16, a CIG event x may occur between an eleventh time point t11 and a fifteenth time point t15. The CIG event x may include the CIS1 event x and the CIS2 event x. For example, the CIS1 event x may occur between the eleventh time point t11 and a fourteenth time point t14, and the CIS2 event x may occur between a twelfth time point t12 and the fifteenth time point t15. That is, the CIS1 event x and the CIS2 event x may share the same time period.

The CIS1 event x may include the CIS1 Sub_interval. For example, the CIS1 Sub_interval may be included between the eleventh time point t11 and the thirteenth time point t13. Similarly, the CIS2 event x may include the CIS2 Sub_interval. For example, the CIS2 Sub_interval may be included between the twelfth time point t12 and the fourteenth time point t14. Detailed descriptions of the CIS events and the CIS subevents are similar to the descriptions provided with reference to FIG. 15, and therefore not further detailed description will be provided.

The CIG event x+1 may occur at a sixteenth time point t16 after the ISO interval has lapsed from the eleventh time point t11. The CIG event x+1 may include the CIS1 event x+1 and the CIS2 event x+1. Detailed descriptions for CIS events included in the CIG event x+1 are similar to the descriptions for the CIG event x, and therefore no further detailed description is provided.

In one or more embodiments, the CIG event may correspond to the unit filtering time UFT previously described with reference to FIG. 1 to FIG. 13. For example, the central device 1000 may perform the voice data filtering operation for each CIG event, and may provide filtered voice data VD_filt to the multi-speaker application module 1300.

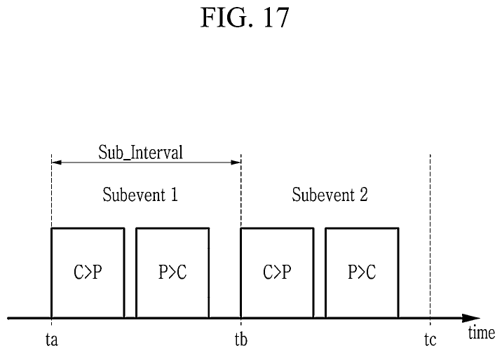

FIG. 17 shows the CIS event shown in FIG. 15 to FIG. 16. Referring to FIG. 14 to FIG. 17, a time point ta to a time point tc may correspond to one CIS event. For example, the time point ta to the time point tc may be the CIS1 event x or the CIS2 event x described above with reference to FIG. 15 or FIG. 16.

Each of a time period between the time point ta and the time point tb, and the time period between the time point tb and the time point to may correspond to one sub-interval (hereinafter, referred to as Sub_interval). For example, a time period between the time point ta and the time point tb may be the CIS1 Sub_interval or CIS2 Sub_interval described above with reference to FIG. 15 to FIG. 16.

One Sub_interval may correspond to one CIS subevent (referred to as a CIS subevent or subevent). For example, the subinterval between the time point ta and the time point tb may include Subevent 1, and the subinterval between the time point tb and the time point tc may include Subevent 2.

During one subevent, the central device 1000 and the peripheral device may transmit and receive data once. For example, during the time period between the time point ta and the time point tb, the central device 1000 may transmit communication data to a peripheral device one time (illustrated as C>P), and the peripheral device may transmit the communication data to the central device 1000 one time (illustrated as P>C).

In one or more embodiments, during one subevent, the peripheral device may transmit the communication in form of a PDU to the central device 1000. In this case, the central device 1000 may be generate a service data unit (SDU) corresponding to voice data by merging the plurality of PDUs received through the plurality of subevents.

FIG. 18 is a block diagram of the central device of FIG. 14 in more detail. Referring to FIG. 1 to FIG. 17, a central device 1000 may include a processing circuit 1100, a data filtering module 1200, a multi-speaker application module 1300, a memory circuit 1400, and a communication circuit 1500. The configuration and functions of the processing circuit 1100, the memory circuit 1400, and the communication circuit 1500 are similar to those of the processing circuit 110, the memory circuit 140, and the communication circuit 150 described with reference to FIG. 2, and therefore no further detailed description will be provided.

The data filtering module 1200 may include a priority management circuit 1210, a data filtering circuit 1220, a filtering notification circuit 1230, and a data merging circuit 1240. The configurations and functions of the priority management circuit 1210, the data filtering circuit 1220, and the filtering notification circuit 1230 are similar to those of the priority management circuit 121, the data filtering circuit 122, and the filtering notification circuit 123 described with reference to FIG. 2, and therefore no further detailed description will be provided.

The data filtering circuit 1220 may receive a plurality of communication data from a first to n-th CIS CIS1 to CISn. For example, the data filtering circuit 1220 may receive a plurality of PDUs from the first to n-th CIS CIS1 to CISn.

The data filtering circuit 1220 may filter the received plurality of protocol data units (PDUs). For example, the data filtering circuit 1220 may filter-out PDUs provided from a peripheral device corresponding to the highest priority value.

The data merging circuit 1240 may merge PDUs output from the data filtering circuit 1220. For example, the data merging circuit 1240 may merge the PDUs output from the data filtering circuit 1220 to generate a service data unit (SDU) corresponding to filtered voice data VD_filt. More detailed operation of the data merging circuit 1240 will be described in more detail with reference to FIG. 16.

In one or more embodiments, the data merging circuit 1240 may operate as an isochronous adaptation layer (ISOAL). However, the scope of the disclosure is not limited thereto.

FIG. 19 is a block diagram of the configuration and operation of the data filtering circuit and the data merging circuit of FIG. 18. Referring to FIG. 14 to FIG. 19, the data filtering circuit 1220 may receive a plurality of PDUs from each of a plurality of CISs. For example, the data filtering circuit 1220 may receive a first plurality of PDUs from a first CIS CIS1 and may receive a second plurality of PDUs from a second CIS CIS2.

The data filtering circuit 1220 may filter the plurality of received PDUs based on a filtering priority FP. For example, the data filtering circuit 1220 may filter-out a plurality of PDUs provided from a peripheral device with the highest priority value. In this case, the plurality of PDUs filtered-out by the data filtering circuit 1220 may be referred to as PDU_filtered.

The data merging circuit 1240 may receive a plurality of filtered-out PDUs PDU_filtered from the data filtering circuit 1220. The data merging circuit 1240 may merge the plurality of filtered-out PDUs PDU_filtered to the SDU. In this case, the SDU may correspond to the filtered voice data VD_filt described above with reference to FIG. 1 to FIG. 13.

While certain embodiments of the disclosure has been particularly shown and described, it will be understood that various changes in form and details may be made therein without departing from the spirit and scope of the following claims.

What is claimed is:

1. An operation method of a data filtering module configured to communicate with a multi-speaker application module, the operation method comprising:
receiving a plurality of communication data from a plurality of external devices respectively;
generating filtered voice data from the plurality of communication data based on a filtering priority determined based on a number of voice data in the plurality of communication data; and
providing the filtered voice data to the multi-speaker application module.

2. The operation method of claim 1, wherein the filtering priority comprises a plurality of priority values respectively corresponding to the plurality of external devices.

3. The operation method of claim 2, wherein the generating the filtered voice data comprises:
extracting voice data from the plurality of communication data;
updating the filtering priority based on the voice data extracted from the plurality of communication data;
selecting a first external device corresponding to a highest priority value, among the plurality of external devices, based on the updated filtering priority; and
filtering-out first voice data provided from the first external device, based on the voice data extracted from the plurality of communication data.

4. The operation method of claim 3, wherein the updating the filtering priority comprises:
based on the number of the voice data extracted from the plurality of communication data being one, increasing a priority value for an external device corresponding to the extracted voice data to a first priority value; and
based on the number of the voice data extracted from the plurality of communication data being at least two, increasing priority values for external devices corresponding to the at least two extracted voice data by a second priority value.

5. The operation method of claim 4, wherein the updating the filtering priority further comprises:
adjusting each of the plurality of priority values by a fourth priority value in a direction of converging to a third priority value.

6. The operation method of claim 5, wherein the first priority value is larger than the third priority value, and
wherein the third priority value is larger than the second priority value.

7. The operation method of claim 6, wherein the second priority value is larger than the fourth priority value.

8. The operation method of claim 2, wherein a second external device is one of the plurality of external devices, and
wherein the operation method further comprises, based on that the filtered voice data corresponds to voice data provided from the second external device continuously during a first time length, reducing a priority value for the second external device to a lower limit value.

9. The operation method of claim 8, further comprising:
based on the priority value for the second external device being reduced to the lower limit value, transmitting a filtering termination notification to each of the plurality of external devices.

10. The operation method of claim 1, wherein the plurality of external devices respectively communicate with the data filtering module through a plurality of connected isochronous streams (CISs) in a first connected isochronous group (CIG), and
wherein the receiving each of the plurality of communication data is performed during a first CIG event for the first CIG.

11. The operation method of claim 10, wherein the first CIG event comprises a plurality of CIS events respectively corresponding to the plurality of CISs, and
wherein the number of voice data in the plurality of communication data is determined based on a number of CIS events transmitting voice data among the plurality of CIS events.

12. The operation method of claim 1, wherein the multi-speaker application module performs a group recording function or a group communication function for the plurality of external devices responding to the filtered voice data.

13. A central device comprising:
a priority management circuit configured to manage a filtering priority based on a number of voice data provided from a plurality of peripheral devices during a first unit filtering time;
a data filtering circuit configured to generate filtered voice data by filtering the voice data provided from the plurality of peripheral devices based on the filtering priority; and
a multi-speaker application module configured to perform a group recording function or a group communication function for the plurality of peripheral devices based on the filtered voice data.

14. The central device of claim 13, wherein the filtering priority comprises a plurality of priority values respectively corresponding to the plurality of peripheral devices.

15. The central device of claim 14, wherein the priority management circuit is further configured to, based on the number of voice data provided from the plurality of peripheral devices during the first unit filtering time being one, increase a priority value corresponding to a peripheral device that provided the one voice data by to a first priority value.

16. The central device of claim 15, wherein the priority management circuit is further configured to, based on a number of voice data extracted from a plurality of communication data being at least two, increase each of priority values corresponding to peripheral devices that provided the at least two voice data by a second priority value.

17. The central device of claim 13, wherein the priority management circuit is further configured to, based on the filtered voice data continuously corresponding to voice data provided from a first peripheral device during a plurality of unit filtering times comprising the first unit filtering time, reduce a priority value corresponding to the first peripheral device to a lower limit value.

18. The central device of claim 17, further comprising a filtering notification circuit configured to transmit a filtering termination notification to each of the plurality of peripheral devices based on the priority value corresponding to the first peripheral device being reduced to the lower limit value.

19. An electronic device configured to receive first to n-th plurality of communication data, during a first to n-th connected isochronous group (CIG) event sequentially occurring respectively, through a first CIG comprising a plurality of connected isochronous streams (CISs), the electronic device comprising:
a priority management circuit configured to manage a filtering priority comprising a plurality of priority values respectively corresponding to the plurality of CISs, based on a number of voice data in each of the first to the n-th plurality of communication data;
a data filtering circuit configured to filter first to n-th voice data from the first to the n-th plurality of communication data based on the filtering priority; and
a multi-speaker application module configured to perform a group recording function or a group communication function for the plurality of CISs based on the first to the n-th voice data.

20. The electronic device of claim 19, wherein, the priority management circuit is further configured to, based on each of the first to the n-th voice data being provided from a first CIS among the plurality of CISs, reduce a priority value corresponding to the first CIS among the plurality of priority values to a lower limit value.
